(19) United States
(12) Patent Application Publication
(10) Pub. No.: US 2002/0143917 A1
(43) Pub. Date: Oct. 3, 2002

(54) Network management apparatus and method for determining network events

(76) Inventors: David James Stevenson, Edinburgh (GB); Hamish Donald Stuart Martin, Edinburgh (GB); Andrew Hunter Gray, West Lothian (GB); Robert James Duncan, Edinburgh (GB)

Correspondence Address: McDonnell Boehnen Hulbert & Berghoff, 32nd Floor, 300 S. Wacker Drive, Chicago, IL, 60606, US

(21) Appl. No.: 09/897,232

(22) Filed: Jul. 2, 2001

(30) Foreign Application Priority Data
Feb. 27, 2001 (GB) GB 0104874.3

(51) Int. Cl. G06F 15/173; G06F 9/46

(52) U.S. Cl. 709/223; 709/318

(57) ABSTRACT

A network management apparatus and method processes network management data in a network management system during the monitoring of a network. The apparatus and method considers whether the network management data indicates that the network condition of an event previously generated by the network management system is no longer present on the network, and therefore resolved. In a preferred embodiment, if the network management data indicates that a previous event has been resolved, the event is marked as resolved for presentation in an event list to the user. The user can then easily identify events which have been resolved.

### CROSS-REFERENCE TO RELATED APPLICATIONS

The following patent applications filed concurrently herewith are related to the present application and are incorporated herein by reference:

U.S. patent application (Attorney Reference 3COM3584) entitled “Processing Network Events to Reduce the Number of Events to be Displayed”;

U.S. patent application (Attorney Reference MBHB01-491) entitled “Apparatus and Method for Processing Data Relating to Events on a Network”, and

U.S. patent application (Attorney Reference MBHB01-493) entitled “Network Management Apparatus and Method for Processing Events associated with Device Reboot”.

### BACKGROUND OF THE INVENTION

1. Field of the Invention

The present invention relates generally to an apparatus and method for the management of a network, and more particularly to a network management apparatus and method capable of generating events when predefined significant conditions are detected.

2. Description of the Related Art

The following description is concerned with a data communications network, and in particular a local area network (LAN). It will be appreciated, however, that the invention but has more widespread applicability to other managed communications systems including wide area networks (WANs) or wireless communications systems. Networks typically comprise a plurality of computers, peripherals and other electronic devices capable of communicating with each other by sending and receiving data packets in accordance with a predefined network protocol. Each computer or other device on the network is connected by a port to the network media, which in the case of a LAN network may be coaxial cable, twisted pair cable or fibre optic cable. A network is generally configured with core devices having a plurality of ports, which can be used to interconnect a plurality of media links on the network. Such devices include hubs, routers and switches which pass data packets received at one port to one or more of its other ports, depending upon the type of device. Such core devices can be managed or unmanaged.

A managed device is capable of monitoring data packets passing through its ports and obtaining data relevant for network management. Managed devices additionally have the capability of communicating this data using a management protocol such as the SNMP (Simple Network Management Protocol), as described in more detail below. The skilled person will appreciate that the invention is not limited to use with SNMP, but can be applied to managed networks using other network management protocols.

SNMP defines agents, managers and MIBs (where MIB is Management Information Base), as well as various predefined messages and commands for communication of management data. An agent is present in each managed network device and stores management data and responds to requests from the manager. A manager is present within the network management station of a network and automatically interrogates the agents of managed devices on the network using various SNMP commands, to obtain information suitable for use by the network administrator, whose function is described below. A MIB is a managed “object” database which stores management data obtained by managed devices and is accessible to agents for network management applications.

It is becoming increasingly common for an individual, called the “network administrator”, to be responsible for network management, and his or her computer system or workstation is typically designated the network management station. The network management station incorporates the manager, as defined in the SNMP protocol, i.e. the necessary hardware, and software applications to retrieve data from MIBs by sending standard SNMP requests to the agents of managed devices on the network.

A part of the network administrator's function is to identify and resolve problems occurring on the network, such as device or link malfunction or failure. In order to provide the network administrator with the necessary information to identify such problems, the network management application monitors the devices on the network. An example of such monitoring is described in UK Patent Application No 9917993.9 (GB-A-2 350 035) entitled “Management System and Method for Monitoring Stress in a Network” in the name of the present assignee. In the system and method described in GB-A-2 350 035 the SNMP manager in the network management station requests the agents of managed network devices on the network to retrieve selected MIB data indicative of device and link operation, and performs tests for device activity and service availability. Such MIB data may relate to characteristics such as traffic activity or errors occurring at a particular port in the relevant network device. Tests may include sending ICMP Ping requests to each device on the network, or sending selected requests for services such as SMTP, NFS and DNS to servers, and monitoring the time taken to receive a response. The monitored parameters or characteristics are referred to herein as “stress metrics”.

The network management application compares, for each stress metric, the retrieved data or test results against a corresponding threshold level for the stress metric. The threshold level is the level above which performance is considered to be unacceptable.

Each time a threshold is exceeded, the application generates and logs an “event” in memory. An “event log” lists each event, and includes information such as the date and time of the event, the identity of the device affected and the nature of the event. The event list thus provides a history of events which have occurred on the network, and the network administrator can review the event list to identify problems on the network.

In addition to events resulting from the monitoring of stress metrics, events may also be generated by the network management application when other types of condition are detected. For example, a network management application may receive an asynchronous Trap, for example an SNMP Trap from a managed network device. An SNMP Trap is automatically sent by an SNMP agent to the SNMP manager when certain conditions are detected by the agent in the managed device. Examples of conditions which cause SNMP Traps to be sent include “link up” and “link down”. When an SNMP Trap is received by the network management station, the management application may log an event.

An example of a known network management software application capable of monitoring, and detecting the above described conditions on, a network is the 3Com® Network Supervisor available from 3Com Corporation of Santa Clara, Calif., USA. This application, and similar applications, uses SNMP commands to retrieve relevant management data from managed network devices, and processes the data accordingly.

A problem with known network management applications is that a large number of events can be recorded in the event log over time. As a consequence, the network administrator can have difficulty in determining which events indicate current problems on the network, which require attention, and events which do not require attention because, for instance, the condition on the network which caused the event to be logged is no longer present.

Accordingly, there is a need for an improved network management apparatus and method which addresses this problem. In the aforementioned co-pending U.S. patent application entitled “Processing Network Events to Reduce the Number of Events to be Displayed” filed simultaneously herewith, there is described a method and apparatus in which events generated by a network management system are passed through one or more “event processors” to correlate events prior to presentation in an event list. Each processor is adapted to correlate certain types of events which may be generated as a result of certain conditions or problems on the network. This correlation ensures that the number of events presented in the event log is reduced, by avoiding listing certain types of event, which, generally speaking, are less informative about network conditions and problems to the network administrator.

### SUMMARY OF THE INVENTION

The present invention provides a method which may be implemented by one such event processor, and an apparatus which may comprise such an event processor.

Generally, the present invention provides a network management apparatus and method which determines that an event has been resolved. In the following description, the term “resolved” is used in relation to existing or historical events relating to network conditions that are no longer present on the network, and network management data which indicates the removal of a network condition indicated in an historical event is said to “resolve” the existing event.

In accordance with a first aspect, the present invention provides a method for processing network management data received by a network management system during the monitoring of a network, the method comprising: receiving network management data, and determining if the network management data indicates the resolution of a previous event generated by the network management system in response to previously received network management data.

If the method determines that the received data indicates the resolution of a previous event, in a preferred embodiment, the method marks the previous event as resolved. Thus, the user can identify which events in the event list are resolved.

In accordance with a second aspect, the present invention provides a computer readable medium including a computer program for carrying out the method of the first aspect of the present invention.

In accordance with a third aspect, the present invention provides a network management system for processing network management data received during the monitoring of a network, the system comprising: a processor for receiving network management data and determining if the network management data indicates the resolution of a previous event generated by the network management system in response to previously received network management data.

Further preferred features and advantages of the present invention will be apparent from the following description and accompanying claims.

### BRIEF DESCRIPTION OF THE DRAWINGS

Embodiments of the present invention will now be described by way of example with reference to the accompanying drawings, in which:

FIG. 1 is a block diagram of a typical network including a network management system which may be used to implement the present invention;

FIG. 2 is flow diagram of the general method steps performed in accordance with an embodiment of the present invention;

FIG. 3 is a flow diagram of the method steps performed by a computer program in accordance with a first preferred embodiment of the present invention;

FIG. 4 is a flow diagram of the method steps performed by a computer program in accordance with a second preferred embodiment of the present invention, and

FIG. 5 is a flow diagram of the method steps performed by a computer program in accordance with a third preferred embodiment of the present invention.

### DESCRIPTION OF THE PREFERRED EMBODIMENTS

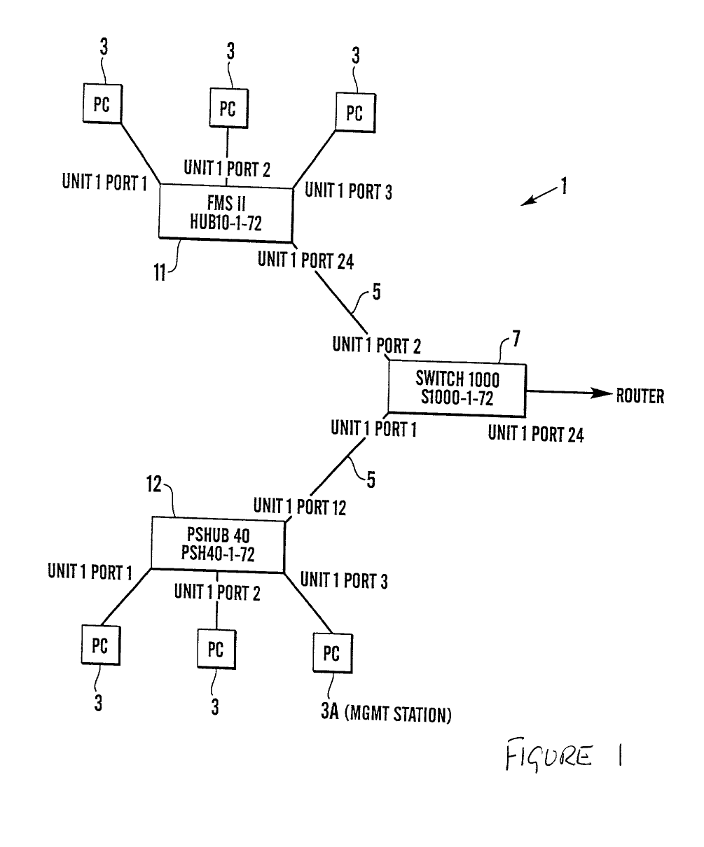

FIG. 1 shows a typical network 1 incorporating a network management system for use in accordance with the present invention. The network 1 includes a network management station 3A which incorporates the necessary hardware and software for network management. In particular, the network management station 3A includes a processor, a memory and a disk drive as well as user interfaces such as a keyboard and mouse, and a visual display unit. Network management application software in accordance with the present invention is loaded into the memory of management station 3A for processing data as described in detail below. The network management station 3A is connected by network media links 5 to a plurality of managed network devices including core devices such as network switch 7, hubs 11 and 12, and a router (not shown) which may be managed or unmanaged, and end stations including personal computers (PCs) 3 and workstations. The network may also include unmanaged devices, for example peripheral devices such as printers.

The network management station 3A is capable of communicating with the managed network devices such as network switch 7 and hubs 11 and 12 by means of a network management protocol, in the present embodiment the SNMP protocol, in order to obtain network management data. In particular, the management station 3A includes the SNMP manager. Each managed device monitors operational characteristics of the network and includes an SNMP agent which stores MIB data in memory on the device, as is well known in the art, and communicates such data to the SNMP manager in the network management station 3A, as described below.

The network management station 3A includes a network management software application which sends SNMP requests to the managed network devices at regular intervals and processes the received MIB data. In addition, the management application may periodically send signals to devices on the network which prompts a response from the device (e.g. by IP ICMP echo or IP Ping, as is known in the art). The network management application will typically monitor the time taken to receive a response from each device. Finally, the network management application may receive and process SNMP Trap signals from managed network devices.

When processing of data by the network management application detects certain predetermined conditions, the network management application will generate an event. For example, if a network device fails to respond to an IP Ping sent by the network management application within a predetermined time period, an event will be generated. Such events are stored in memory and placed in an event list for presentation e.g. by display on a display screen or by printing in a report. For each event, the information recorded (i.e. event data) includes the time of the event (typically by means of a “time stamp”), the identity of the device concerned, the type or nature of the event, and the severity of the event. The severity of the event is dependent on the type of event and the type of device concerned, and is included to assist the administrator is determining which events indicate problems which require the most urgent attention. Thus events such as an end station not responding to IP Ping has a “Low” severity, whereas a similar event for a core device has a “High” severity.

The following Table is an example of an event list which may be produced for the network 1:

| Time | Device Name | Description | Severity |
|---|---|---|---|
| 11.01 | HUB10-1-72 | Utilisation on port 2 exceeded 80% | HIGH |
| 11.03 | S1000-1-72 | Errors on port 1 exceeded 5% | HIGH |
| 11.06 | HUB10-1-72 | Utilisation on port 2 exceeded 80% | HIGH |
| 11.00 | S1000-1-72 | Errors on port 24 exceeded 5% | HIGH |
| 10.58 | S1000-1-72 | Errors on port 2 exceeded 5% | HIGH |
| 10.58 | PSH40-1-72 | Broadcasts on port 12 exceeded 200/s | HIGH |
| 10.57 | HUB10-1-72 | Utilisation on port 2 exceeded 80% | HIGH |
| 10.56 | S1000-1-72 | Utilisation on port 24 exceeded 80% | HIGH |

The Table indicates a large number of events having a High severity, received over a time period of 5 minutes. Thus, for a longer period of time, which would be more typical of the time interval between reviews of the event list, the network administrator will have difficulty in determining which events in the event list indicate current network problems requiring attention.

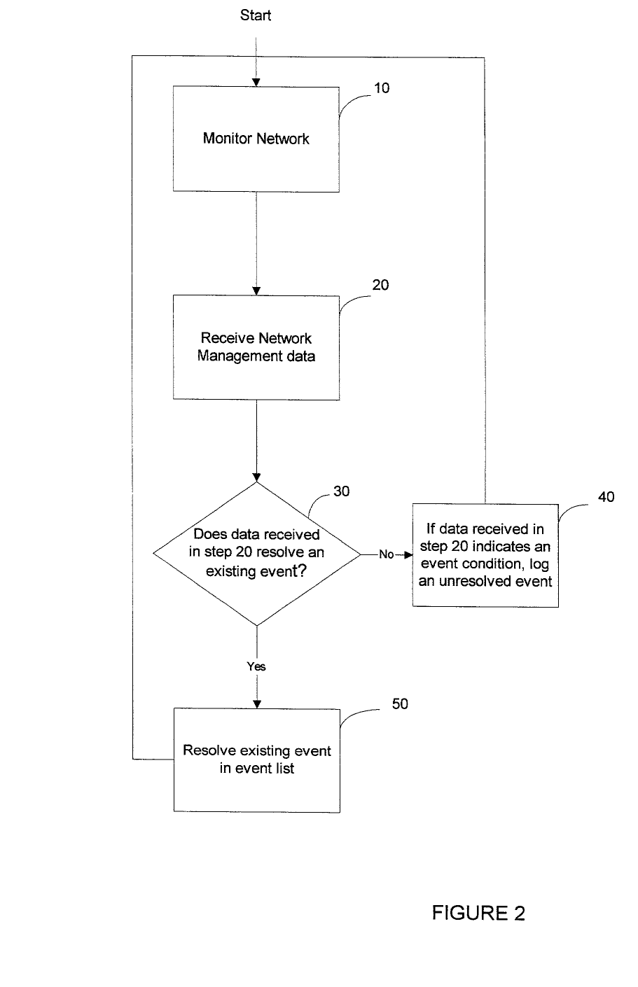

FIG. 2 illustrates a method in accordance with an embodiment of the present invention which may be employed by the network management station 3A to address this difficulty. The method is preferably implemented in the form of a computer program forming part of a network management software application. It will be appreciated that the invention may be implemented in other forms such as hardware.

At step 10, the program monitors the network using conventional monitoring techniques as described above. At step 20, the program receives network management data resulting from the monitoring in step 10. The network management data may be data retrieved from the network during the monitoring process, or may be data relating to events generated by the network management software application as a result of an event condition being observed during previous monitoring of the network or by the (real time) monitoring in step 10.

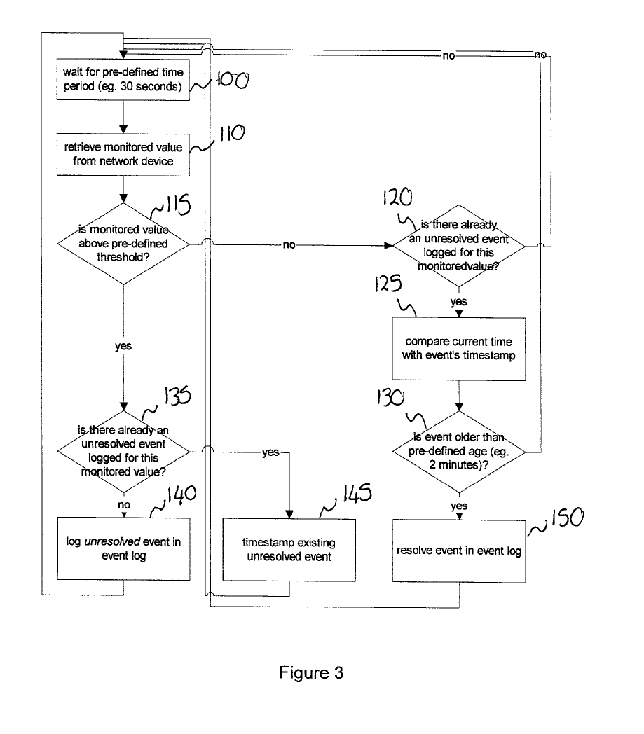

At step 30 the program receives the data from step 20 and considers whether it resolves an existing event in the event list, i.e. an event received previously (“previous event”). The manner in which the program determines whether the data resolves an existing event is dependent on the type of data and/or event, and examples are given below in relation to the preferred embodiments illustrated in FIGS. 3 to 5.

If step 30 determines that the data received from step 20 does not resolve an existing event, the program continues with step 40. At step 40, if the data from step 20 indicates a recordable event condition, the program generates and logs an unresolved event in the event log and returns to step 10.

If step 30 determines that the data received from step 20 does resolve an existing event, the program continues with step 50 by “resolving” the existing event. In particular, the existing event is marked as resolved in memory in the event log and the word “resolved”, or its equivalent, is indicated in the information relating to the event in the event list for presentation to the user. The program then returns to step 10.

It will be appreciated that in some embodiments, if the data received at step 20 relates to (recordable) events which resolve previous events, then such events are preferably not placed in the event list for presentation to the user, but instead the existing event is marked as resolved in the event list.

In certain preferred embodiments, illustrated in FIGS. 2, 3 and 4, the program is carried out in real time in response to the network management application receiving network management data from the network. This ensures that the event list is updated continuously so that the event list presented to the network administrator always indicates the current state of the network. It will be appreciated that in other embodiments the program could be used by the network administrator to process a plurality of events already appearing in the event list to determine which events are resolved.

In addition, in the preferred embodiments, the program not only marks resolved events as resolved, but also changes the severity of the resolved event. In particular, a different severity may be applied to all resolved events, or the severity may be reduced according to the type of event. By changing the severity indication of a resolved event, the network administrator can apply conventional filters to the event list to remove resolved events. The filtered list then only includes unresolved events. In addition, if the severity for resolved events is reduced to “Low”, management systems with limited memory space for the event log will automatically preferentially delete these events along with other low severity events.

In another embodiment, resolved events may be marked as resolved by changing the severity to “Resolved”, thus combining the two aforementioned steps.

The following description relates to three different examples of the type of event which may be determined to be resolved in accordance with the present invention. These types are:

1. Events generated as a result of a value of a monitored metric crossing a pre-defined threshold. These events may be considered to be resolved if the value of the monitored metric has been consistently below the pre-defined threshold for the previous m seconds. A program for resolving this type of event is illustrated in FIG. 3.

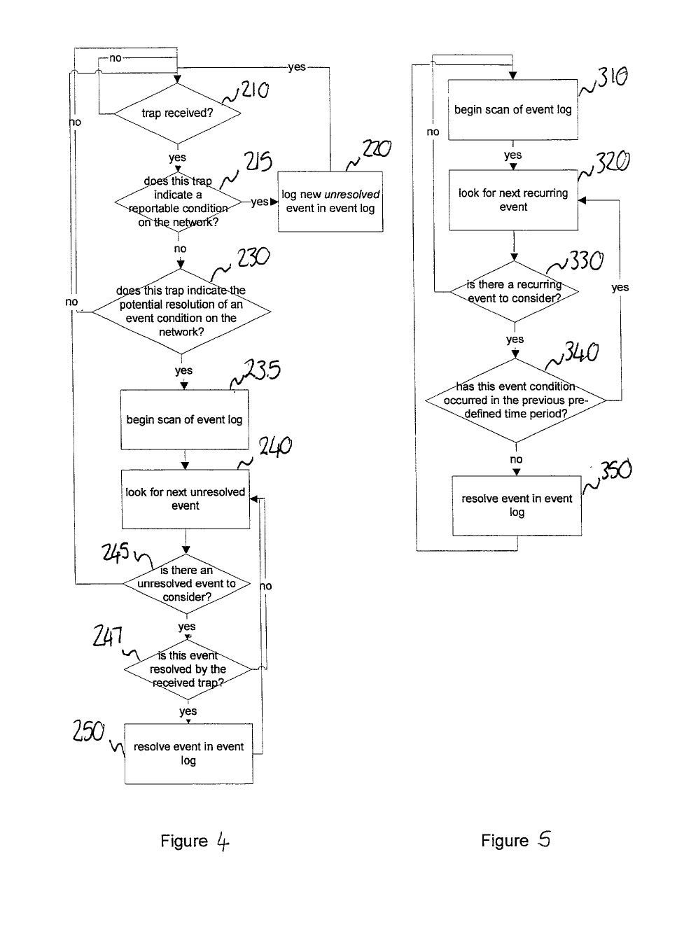

2. Events generated as a result of receiving an asynchronous Trap. These events may be considered to be resolved if a further asynchronous trap is received which indicates that the earlier condition no longer applies. A program for resolving this type of event is illustrated in FIG. 4.

3. Events generated as a result of a “recurring event”. These events may be considered to be resolved if the recurring event has not recurred in the previous n seconds. A program for resolving this type of event is illustrated in FIG. 5.

Note that for events of type 1 and 3 parameters m and n will typically be dependent on the particular event type under consideration.

FIG. 3 illustrates the program steps used to resolve type 1 events in accordance with a method forming a first preferred embodiment of the present invention.

The program is concerned with a particular monitored characteristic of a particular network device. Thus, it will be appreciated that, in practice, a number of the programs illustrated in FIG. 3 may be running simultaneously for different devices and different characteristics, and each program only receives monitored values for the relevant device and characteristic.

The program begins when the monitoring of the network begins or immediately after an event for the relevant characteristic of the relevant device has been resolved. In this embodiment, a value for the monitored characteristic is received at regular periodic time intervals (e.g. every 30 or 60 seconds) by the retrieval of MIB data from a managed network device by the network management application.

At step 100, the program waits a predefined time period. The predefined time period is dependent on the monitored characteristic and the frequency that network management data is retrieved by the network management application. For example, the predefined time period may be 30 seconds. Other time periods are possible. After the predefined time period, the program continues with step 110.

At step 110, the program receives a value for the monitored characteristic of the relevant network device.

At step 115, the program considers whether the monitored value received at step 110 exceeds the predefined threshold for the monitored characteristic. If the monitored value exceeds the threshold, the program continues with step 135. Otherwise the program continues with step 120, described below.

It will be appreciated that steps 100 to 115 may be carried out by a conventional network management application, and if an event is detected, the network management data is passed to step 135, otherwise it is passed to step 120.

Step 135 considers whether there is already an unresolved event logged for the monitored characteristic and the relevant network device by scanning the event log. If step 135 determines that there is not an unresolved event in the event log, the program proceeds to step 140 by generating and logging an event in the event log. The event is logged as an unresolved event and will appear as an unresolved event in the event list.

Alternatively, if step 135 determines that there is an unresolved event in the event log, the program proceeds to step 145 by updating the time of the existing unresolved event with the time of the monitored value received at step 110. This means that the time indicated in the event data of an unresolved event is always the time of the most recent occurrence of the event condition. It will be appreciated that in other embodiments a time stamp could be applied to the existing event in addition to its own time stamp in the event data.

Following either step 140 or step 145, the program returns to step 100.

Returning now to step 120, which follows if step 115 determines that the monitored value received at step 110 does not exceed the predefined threshold for the monitored characteristic, the program now determines if there are any unresolved events logged for the monitored characteristic and the relevant network device which may now be resolved.

Thus, at step 120, the program considers whether there is already an unresolved event logged for the monitored characteristic and the relevant network device by scanning the event log. If step 120 determines that there is not an unresolved event in the event log the program returns to step 100. Alternatively, if step 120 determines that there is an unresolved event in the event log the program continues with step 125 by comparing the current time with the time of the most recent occurrence of the event condition in the event data of the unresolved event(s), and determining the time difference.

At step 130, the program compares the time difference determined in step 125 with a predefined time interval, (e.g. 2 minutes). The predefined time interval is dependent upon the monitored characteristic and the device involved and is chosen to reflect an age at which the event may be considered to be resolved.

If step 130 determines that the time difference, and therefore the age of the unresolved event, is greater than the predefined time interval the program proceeds to step 150. Otherwise, the program returns to step 100.

In summary, steps 120, 125 and 130 determine whether the monitored value has been below the predefined threshold for an immediately preceding predefined time period, which is defined to indicate the resolution of an event for the monitored characteristic. The skilled person will appreciate that in other embodiments, other techniques may be used. For example, in another embodiment performed in real time, if there is already an unresolved event, on the first occasion that the monitored value received at step 115 is below the threshold, the program would set a timer to expire at the end of the predefined time period. If a subsequent received value is above the threshold, the timer would be cancelled, but otherwise would be left to run. Upon expiry of the timer, it is determined that the monitored value has been below the predefined threshold for the preceding predetermined time period.

At step 150, having established that the conditions for event resolution are satisfied, the program resolves the existing unresolved event. In particular, the program marks the event in the event log as resolved for presentation to the user. The program then returns to step 100.

FIG. 4 illustrates the program steps used to resolve type 2 events in accordance with a method forming a second preferred embodiment of the present invention.

The program is concerned with a particular asynchronous Trap relating to a particular network device. Thus, it will be appreciated that, in practice, a number of the programs illustrated in FIG. 4 may be running simultaneously for different devices and different Trap types, and each program may only receive Trap information for the relevant device and Trap type.

The program begins when the monitoring of the network begins or immediately after an event for the relevant Trap of the relevant device has been logged or resolved.

At step 210, the program periodically considers whether a relevant Trap has been received. When a relevant Trap is received, the program continues with step 215 by considering whether the received Trap is a reportable event condition on the network.

If step 215 determines that the received Trap is a reportable event condition, the program continues with step 220 by generating and logging an event in the event log. The event is logged as an unresolved event and will appear as an unresolved event in the event list. The program then continues with step 210.

If step 215 determines that the received Trap is not a reportable event, the program continues with step 230, described below.

At step 230 the program considers whether the received Trap indicates the potential resolution of an event condition on the network. In particular, the program compares the type of the received Trap with predefined Trap types which can, by their type alone, indicate the resolution of an event. These predefined types of Trap are stored in a list in memory and accessible to the program. The skilled person will appreciate the types of Trap which may be listed as indicating the resolution of an event, examples of which are given below.

If step 230 determines that the received Trap indicates the potential resolution of an event condition on the network, the program continues with step 235.

If step 230 determines that the received Trap does not indicate the potential resolution of an event condition on the network monitored, the program returns to step 210. In other words, the Trap is ignored since it is indicative of an unreportable condition that does not resolve an earlier event.

At step 235, the program begins a scan of the event log, and at step 240 it looks for an unresolved event. At step 245 the program considers whether there is an unresolved event to consider.

If step 240 does not find an unresolved event, step 245 determines that there is no unresolved event to consider and the program returns to step 210. Thus, the Trap event is again ignored.

If step 240 does find an unresolved event, step 245 determines that there is an unresolved event to consider and the program continues with step 247 by considering whether the received Trap resolves the unresolved event found in step 240. In particular, step 247 compares the event type of the unresolved event with the type of the received Trap. The aforementioned memory, which stores the list of Trap types which can indicate the resolution of an event, also includes a list of the types of event which are resolved by the Trap type. Thus, for instance, the SNMP “link up” Trap is a type of Trap which may indicate the resolution of the “link down” event type (which is caused by receiving an SNMP “link down” Trap). These Trap and event types are stored together in the memory.

If step 247 determines that the received Trap does not resolve the unresolved event found in step 240, the program returns to step 240 and continues the scan of the event list by looking for the next unresolved event.

If step 247 determines that the received Trap does resolve the unresolved event found in step 240, the program continues with step 250 by resolving the event found in step 240. In particular, the program marks the event in the event list as resolved. The program then returns to step 240 since the received Trap may resolve further previous events. It will be appreciated that in other embodiments, the program may return to step 210, since in most cases a Trap typically resolves only one previous event.

FIG. 5 illustrates the program steps used to resolve type 3 events in accordance with a method forming a third preferred embodiment of the present invention.

In the embodiment of FIG. 5, unlike the embodiments of FIGS. 3 and 4, and the general example of FIG. 2, is used by the network administrator to process a plurality of events already appearing in the event list to determine if one or more “recurring” events have been resolved.

At step 310, the program begins a scan of events in the event log and at step 320 the program looks for a “recurring event”. A recurring event is an event or a plurality of events indicating, and resulting from, an intermittent event condition or problem on the network. In the preferred embodiment, a recurring event is an event which is marked as recurring and is generated by an event processor after a particular event condition has occurred a plurality of times in a predetermined time interval.

In particular, in the preferred embodiment, every time an identical event condition is detected in the network management application, an event is generated and logged in memory. Each time the event is logged, the application checks the number of times the event has been logged in a previous time period. If the event has already been logged a predetermined number of times, it generates a recurring event for presentation in the event list, and future occurrences of the event condition are logged in memory but not presented in the event list, and thus hidden from the network administrator. In addition, a second time stamp is applied to the recurring event, which is updated each time the event is subsequently logged. Thus, the second time stamp corresponds to the most recent time the recurring event occurred.

Further details about the preferred way of generating recurring events is provided in the aforementioned co-pending patent application entitled “Apparatus and Method for Processing Data Relating to Events on a Network” (Attorney reference MBHB01-491) filed simultaneously herewith and incorporated herein by reference. It will be appreciated that other ways of determining the presence of a recurring event and/or generating a recurring event may be possible.

At step 330, the program considers whether there is a recurring event to consider.

If step 320 does not find a recurring event, the program returns to step 310. If step 320 does find a recurring event, step 330 determines that there is a recurring event to consider and the program continues with step 340.

At step 340 the program considers whether the event condition indicated in the recurring event has occurred in a previous predefined time period of n seconds. The value of n is predetermined and is dependent on the nature of the event condition concerned. Typically n=7200, indicating a time period of 2 hours, although other time periods are possible. In particular, in the preferred embodiment, the program compares the present time with the time of the second time stamp, corresponding to the last time the event occurred. If the time difference is greater than of equal to the predefined time period of n seconds, the program determines that the event condition indicated in the recurring event has not occurred in a previous predefined time period of n seconds. Alternatively, if the time difference is less than the predefined time period, the program determines that the event condition indicated in the recurring event has occurred in a previous predefined time period of n seconds.

If step 340 determines that the event condition indicated in the recurring event has occurred in the preceding predefined time period, then the event remains unresolved, and the program returns to step 320 by looking for the next recurring event in the event log.

If step 340 determines that the event condition indicated in the recurring event has not occurred in the preceding predefined time period, then the event is considered to be resolved. The program continues with step 350 by resolving the recurring event found in step 330. In particular, the program marks the recurring event in the event list as resolved, for presentation to the user. The program then returns to step 320 by looking for the next recurring event in the event list.

As indicated above, the method of the present invention is performed in a network management station in accordance with the present invention. The network management station 3A comprises a processor, a disk drive, memory, and user interfaces including a display screen, keyboard, mouse, and a printer. The computer program described above is typically provided on a computer readable medium, such as a disk, and is loaded onto the network management station using the disk drive and the processor runs the program. Alternatively, the computer program may be carried on a computer system having the website of, for example, the supplier of network devices, which permits downloading of the program over the Internet on a carrier wave to the network management station 3A.

Various changes and modifications may be made to the described embodiments.

For example, the present invention is not restricted to the described methods for marking an event as “resolved”, either in terms of the data in memory or the information presented in the event list to the user. For example, the severity indication need not be used in marking the event and the word “resolved” need not be used. Other words, symbols or indications may be used, such as a change in colour of the event information.

It is intended to include all such variations, modifications and equivalents which fall within the spirit and scope of the present invention as defined in the accompanying claims.

1. A method for processing network management data received by a network management system during the monitoring of a network, the method comprising: receiving network management data, and determining if the network management data indicates the resolution of a previous event generated by the network management system in response to previously received network management data.

2. A method as claimed in claim 1, wherein, if the network management data indicates the resolution of a previous event, the method further comprises marking the previous event as resolved.

3. A method as claimed in claim 1, wherein the network management data is processed in response to the network management system receiving network management data from the network.

4. A method as claimed in claim 1, the network management data comprising values of a monitored characteristic of a part of the network for which an event is generated if the monitored value exceeds a predetermined threshold, wherein an event list includes an unresolved previous event for the monitored characteristic, wherein the step of receiving network management data comprises receiving a value for the monitored characteristic, and the step of determining comprises considering whether the monitored value has been below the predetermined threshold for a preceding time period, and if so determining that the received value indicates the resolution of the unresolved previous event.

5. A method as claimed in claim 4, wherein the step of considering comprises, in response to receiving the network management data, comparing a first received value for the monitored characteristic with the predefined threshold, and if the value is below the predefined threshold, starting a timer, the timer expiring at the end a predefined time period.

6. A method as claimed in claim 5, wherein the step of considering further comprises comparing each subsequent received value for the monitored characteristic with the predefined threshold, and if any value exceeds the threshold cancelling the timer.

7. A method as claimed in claim 5, wherein, when the timer expires, determining that the monitored value has been below the predetermined threshold for the preceding time period.

8. A method for processing data representing a monitored characteristic of a part of the network in a network management system, the method comprising: periodically receiving a value for the monitored characteristic; if a received value exceeds a predetermined threshold for the monitored characteristic generating an event; and thereafter, periodically considering whether the monitored value has been below the predetermined threshold for a preceding time period, and if so determining that the event is resolved.

9. A method as claimed in claim 8, wherein the preceding time period is an immediately preceding predetermined time period, and the step of periodically considering comprises considering whether the monitored value has been below the predetermined threshold for the immediately preceding time period in response to each subsequently received value.

10. A method as claimed in claim 8, wherein if the step of considering determines that the event is resolved, the method further comprises marking the event as resolved.

11. A method as claimed in claim 1, the network management data relating to an asynchronous Trap being received by the network management system, wherein the step of determining comprises considering if the Trap indicates the possible resolution of an event in an event log.

12. A method as claimed in claim 11, wherein if the Trap indicates the possible resolution of an event in an event log, the step of determining further comprises considering whether the event log includes a previously received event that is resolved by the Trap.

13. A method for processing data received in an asynchronous Trap by a network management system, the method comprising: receiving a Trap from the network; considering if the Trap indicates the possible resolution of a event in an event log, and if so considering whether the event log includes a previously received event that is resolved by the Trap.

14. A method as claimed in claim 1, wherein the method processes network management data previously received by the network management system and stored in memory.

15. A method as claimed in claim 14, wherein the step of receiving network management data comprises receiving event data relating to an event stored in memory, in response to a scan of previously generated events stored and included in an event log.

16. A method as claimed in claim 15, wherein the event data relates to a recurring event and includes the time of the last occurrence of the event.

17. A method as claimed in claim 16, wherein the step of determining comprises comparing the present time with the time of the last occurrence of the event, and, if the time difference is greater than a predetermined time interval, determining that the event is resolved.

18. A method as claimed in claim 17, wherein if the step of determining determines that the event is resolved, the method further comprises marking the recurring event as resolved.

19. A method for processing event data generated by a network management system during the monitoring of a network, the method processing event data relating to events previously generated by the network management system a plurality of times and which may be entered in the event log as a recurring event, the method comprising identifying an event to be processed from the event list; and considering whether the condition which caused the event to be generated has occurred in a preceding time period.

20. A method as claimed in claim 19, wherein, if the step of considering determines that the condition which caused the event to be generated has not occurred in the preceding time period, determining the event to be resolved.

21. A method as claimed in claim 20, further comprising marking the event in the event list as resolved.

22. A computer readable medium including a computer program for processing network management data received by a network management system during the monitoring of a network; the program comprising a program step for receiving network management data and for determining if the network management data indicates the resolution of a previous event generated by the network management system in response to previously received network management data.

23. A network management system for processing network management data received during the monitoring of a network, the system comprising: a processor for receiving network management data and determining if the network management data indicates the resolution of a previous event generated by the network management system in response to previously received network management data.

24. A network management system as claimed in claim 23, further comprising memory for storing data relating to events generated by the system, wherein if the processor determines that received network management data indicates the resolution of a previous event stored in the memory, the processor updates the memory to mark the previous event as resolved.

25. A network management system as claimed in claim 24, further comprising means for presenting an event list of generated events to a user.
